(19) United States
(12) Patent Application Publication
(10) Pub. No.: US 2026/0369939 A1
(43) Pub. Date: Nov. 19, 2026

(54) DECOUPLED FLOAT CONNECTOR MATE ASSURANCE

(71) Applicant: Molex, LLC, Lisle, IL (US)

(72) Inventors: Tommy Lawrence, Little Rock, AR (US); Noah Matthew Mejia, Benton, AR (US)

(21) Appl. No.: 19/636,919

(22) Filed: Apr. 2, 2026

Related U.S. Application Data
(60) Provisional application No. 63/807,319, filed on May 16, 2025.

(51) Int. Cl. H01R 13/74

(52) U.S. Cl. CPC H01R 13/748

(57) ABSTRACT

Decoupled floating connectors mounted on connector racks and bulkheads are described. An example rack assembly includes a support wall and connector assembly extending through an opening in and mounted to the support wall with a floating fastener. The connector assembly includes a decoupling bracket with a first and second elongated apertures. The first elongated aperture can be elongated in a first direction, and the second elongated aperture can be elongated in a second direction perpendicular to the first direction. The connector assembly also includes a housing bracket mounted with the decoupling bracket using a fastener extending into the first elongated aperture, and a housing mounted to the housing bracket. The connector assembly is mounted to the support wall with the floating fastener extending through the second elongated aperture of the decoupling bracket. The connector assembly is decoupled from and can move to some extent with respect to the support wall.

### BACKGROUND

A range of input/output (I/O) connectors are designed for power, data, and power and data interconnect systems, including board-to-board, wire-to-wire, and wire-to-board systems. A variety of designs exist for each type of system, depending on the requirements of the power and data communications environment in which the connectors are used. As one example, a wire-to-board system includes a free-end connector attached to one or more wires and a fixed-end connector attached to a printed circuit board (PCB). As another example, a wire-to-wire system includes a first free-end connector attached to one or more wires and a second free-end connector attached to one or more other wires.

A range of computing, telecommunications, and related systems rely upon arrays of connectors or connector assemblies to provide data connectivity between computing environments, computing devices, switches, routers, and other equipment. In some cases, the arrays of connector assemblies are arranged with and secured to connector panels, connector racks, bulkheads, or other supporting structures using fasteners, such as screws, bolts, rivets, clips, latches, and other fasteners.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

Decoupled floating connectors mounted on connector racks and bulkheads are described. An example rack assembly includes a support wall and a connector assembly extending through an opening in and mounted to the support wall with a floating fastener. The connector assembly includes a decoupling bracket with a first and second elongated apertures. The first elongated aperture can be elongated in a first direction, and the second elongated aperture can be elongated in a second direction perpendicular to the first direction. The connector assembly also includes a housing bracket mounted with the decoupling bracket using a fastener extending into the first elongated aperture, and a housing mounted to the housing bracket. The connector assembly is mounted to the support wall with the floating fastener extending through the second elongated aperture of the decoupling bracket.

The first elongated aperture can be positioned along a first peripheral edge of the decoupling bracket, and the second elongated aperture can be positioned along a second peripheral edge of the decoupling bracket. In some cases, the first elongated aperture includes a first plurality of elongated apertures each elongated in the first direction, and the second elongated aperture includes a second plurality of elongated apertures each elongated in the second direction.

In other aspects, the housing bracket includes a bushing, the bushing extends into the first elongated aperture of the decoupling bracket, and the fastener is threaded into the bushing, within the first elongated aperture. The bushing can slide within the first elongated aperture in the first direction. Additionally, in some cases, a shank of a standoff screw of the floating fastener can slide within the second elongated aperture in the second direction.

In other aspects, the floating fastener includes a plurality of floating fasteners, and each floating fastener can extend through a respective second elongated aperture among the second plurality of elongated apertures of the decoupling bracket and is secured into a threaded aperture in the support wall. The housing bracket can also include a plurality of bushings, and each bushing can extend into a respective first elongated aperture among the first plurality of elongated apertures of the decoupling bracket.

The floating fastener can include a bias spring, a float bearing ring that contacts the decoupling bracket, and a standoff screw having a head with a bearing surface and a shank. The shank can extend through a center of the bias spring and through the float bearing ring, where the bias spring extends and applies forces against the bearing surface of the standoff screw and against the float bearing ring.

An example connector assembly includes a decoupling bracket with a first elongated aperture and a second elongated aperture and a housing mounted with the decoupling bracket using a fastener extending into the first elongated aperture. The first elongated aperture can be elongated in a first direction and the second elongated aperture being elongated in a second direction perpendicular to the first direction. The connector assembly can also include a housing bracket in some cases. The housing can be mounted to the housing bracket, and the housing bracket can be mounted with the decoupling bracket using the fastener extending into the first elongated aperture. The first elongated aperture can be positioned along a first peripheral edge of the decoupling bracket, and the second elongated aperture can be positioned along a second peripheral edge of the decoupling bracket.

The housing includes a bushing in other aspects of the embodiments. The bushing extends into the first elongated aperture of the decoupling bracket, and the fastener is threaded into the bushing, within the first elongated aperture. The bushing can slide within the first elongated aperture in the first direction. The connector assembly can also be mounted to a support wall with a floating fastener that extends through the second elongated aperture of the decoupling bracket. A shank of a standoff screw of the floating fastener can slide within the second elongated aperture in the second direction.

Another example connector assembly includes a decoupling bracket with a first elongated aperture, a housing comprising a bushing, and a fastener. The bushing extends into the first elongated aperture of the decoupling bracket, and the fastener is mechanically coupled with the bushing, within the first elongated aperture. The first elongated aperture can be elongated in a first direction, and the decoupling bracket can also include a second elongated aperture elongated in a second direction perpendicular to the first direction.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a front view of an example connector rack assembly according to various aspects of the present disclosure.

FIG. 1B illustrates a rear view of the example connector rack assembly shown in FIG. 1A according to various aspects of the present disclosure.

FIG. 2A illustrates a front perspective view of an example connector assembly in the connector rack assembly shown in FIG. 1A according to various aspects of the present disclosure.

FIG. 2B illustrates a back perspective view of the connector assembly shown in FIG. 2A according to various aspects of the present disclosure.

FIG. 3A illustrates a front perspective view of the housing bracket and the decoupling bracket of the connector assembly shown in FIG. 2A according to various aspects of the present disclosure.

FIG. 3B illustrates a back perspective view of the housing bracket and the decoupling bracket shown in FIG. 3A according to various aspects of the present disclosure.

FIG. 4A illustrates another front perspective view of the connector assembly shown in FIG. 2A, with parts exploded away from each other, according to various aspects of the present disclosure.

FIG. 4B illustrates a top-down view of the connector assembly shown in FIG. 2A, with parts exploded away from each other, according to various aspects of the present disclosure.

FIG. 5A illustrates a top-down view of parts of the connector rack assembly shown in FIG. 1A according to various aspects of the present disclosure.

FIG. 5B illustrates another top-down view of parts of the connector rack assembly shown in FIG. 1A according to various aspects of the present disclosure.

FIG. 6A illustrates a back view of the connector assembly shown in FIG. 2A according to various aspects of the present disclosure.

FIG. 6B illustrates the sectional view of the connector assembly designated A-A in FIG. 5A according to various aspects of the present disclosure.

FIG. 7A illustrates a perspective view of an example floating fastener of a connector assembly according to various aspects of the present disclosure.

FIG. 7B illustrates an exploded view of components of the floating fastener shown in FIG. 7A according to various aspects of the present disclosure.

FIG. 7C illustrates a sectional view of a bearing ring of the floating fastener shown in FIG. 7A according to various aspects of the present disclosure.

FIG. 7D illustrates a sectional view of the floating fastener shown in FIG. 7A according to various aspects of the present disclosure.

### DETAILED DESCRIPTION

As noted above, a range of input/output (I/O) connectors are designed for power, data, and power and data interconnect systems, including board-to-board, wire-to-wire, and wire-to-board systems. As also noted, a variety of designs exist for each type of system, depending on the requirements of the power and data communications environment in which the connectors are used. As one example, a wire-to-board system includes a free-end connector attached to a wire and a fixed-end connector attached to a board. As another example, a wire-to-wire system includes a first free-end connector attached to one or more wires and a second free-end connector attached to one or more other wires. Such a wire-to-wire system can also be referred to as a cable assembly.

Arrays of connectors and cable assemblies can be arranged with and secured to connector panels, connector racks, bulkheads, or other supporting structures using fasteners, such as screws, bolts, rivets, clips, latches, and other fasteners. A connector rack or bulkhead can refer to a structure including a support wall, to which one or more connectors are mounted or otherwise secured. The connectors can extend through openings or apertures formed in the support wall. The connector rack or bulkhead thus supports the connectors and secures them in place with respect to each other and the surrounding system, device, or apparatus. Connector racks or bulkheads can be particularly helpful for wire-to-wire systems or cable assemblies including two or more free-end connectors positioned at the ends of wire or cable bundles. The connector rack or bulkhead can support a first group of the free-end connectors, and a second group of free-end connectors can be mechanically and electrically connected to the first group of the free-end connectors.

It can be difficult to achieve and maintain precise alignment among connectors supported on a connector rack or bulkhead. It can be challenging, for example, to maintain consistent spacing between the housings and the electrical terminals within the connectors, when an array of many connectors are arranged in and supported by a connector rack or bulkhead. In such cases, the inter-connector spacings among the connectors, the housings of the connectors, and the electrical terminals within the connectors can fall outside of the specifications for alignment. Connector racks, the connectors supported on the racks, and the electrical terminals within the connectors can be damaged during mating operations in some cases due to such misalignments. Additionally, over-mate conditions can result in damage to the connectors supported by a rack or bulkhead. Over-mate damage can occur when an individual applies excessive forces between a pair of mating connectors or connector assemblies supported by a connector rack or bulkhead.

Aspects of the embodiments are directed to decoupled float connector mate assurance and decoupled floating connectors on connector racks and bulkheads. The decoupled float connectors described herein are designed to allow some degree of misalignment, movement, or both misalignment and movement in respective X, Y, and Z directions, for example, between connector components. The term float or floating suggests a level of flexibility, tolerance, or play in movement, permitting the accommodation of variations in alignment, position, angle, and forces applied among structures. The flexibility can be helpful to accommodate manufacturing tolerances, thermal expansion, vibration, and other factors in connectors and connector racks, bulkheads, and other support structures for connectors. Floating connectors can be helpful in applications where precise dimensional spacing is challenging among connectors, where shocks, over-mate conditions, vibrations, and other factors are expected, and in other situations.

In the context described above, decoupled floating connectors mounted on connector racks and bulkheads are described. An example rack assembly includes a support wall and a connector assembly extending through an opening in and mounted to the support wall with a floating fastener. The connector assembly includes a decoupling bracket with first and second elongated apertures. The first elongated aperture is elongated in a first direction, and the second elongated aperture is elongated in a second direction perpendicular to the first direction. The connector assembly also includes a housing bracket mounted with the decoupling bracket using a fastener extending into the first elongated aperture, and a housing mounted to the housing bracket. The connector assembly is mounted to the support wall with the floating fastener extending through the second elongated aperture of the decoupling bracket. The connector assembly is decoupled from and can move, to some extent, with respect to the support wall.

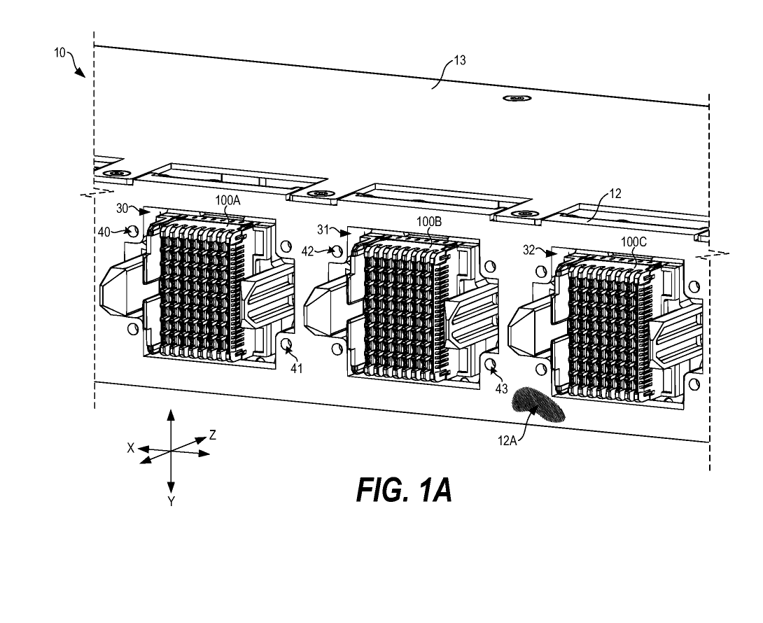

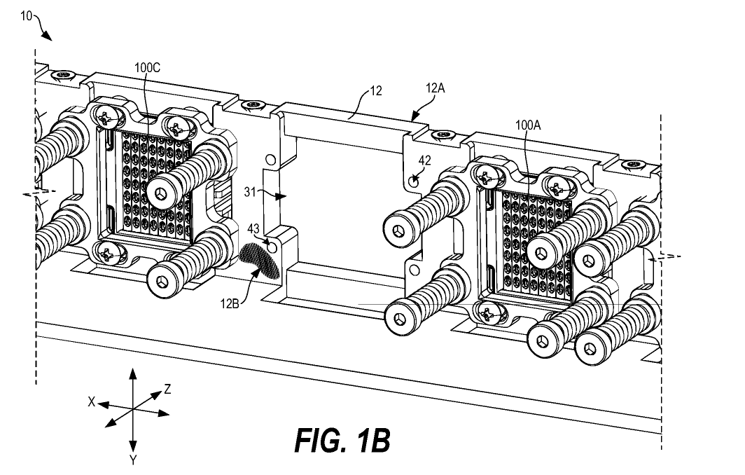

Turning to the drawings, FIG. 1A illustrates an example connector rack assembly 10 (also “rack assembly 10”) according to various aspects of the present disclosure. The rack assembly 10 is illustrated as a representative example and is not drawn to any particular scale or size. The shape, size, proportion, and other characteristics of the rack assembly 10 can vary as compared to that shown. The number, shape, size, proportion, and other characteristics of the connectors in the rack assembly 10 can also vary as compared to that shown. The rack assembly 10 and connectors in the rack assembly 10 can be used in a range of high speed backplane and related interconnect applications, but the concepts are not limited to use with such interconnect applications or systems. The concepts can be extended to use in other types of interconnect applications and systems.

The rack assembly 10 includes a support bracket 12, a housing cover 13, and a number of connector assemblies 100A-100C (also “connectors 100A-100C”), among other components. The connectors 100A-100C are secured to the support bracket 12. The support bracket 12 includes a front surface 12A and a rear surface 12B (see FIG. 1B), among other surfaces. The support bracket 12, among other components of the rack assembly 10, can be formed from a range of different materials. As examples, the support bracket 12 can be formed from metal, polymer materials (e.g., plastics), wood, fiberglass, resin, glass, composite materials (e.g., combinations of materials) and other suitable materials in any suitable way (e.g., by casting, molding, printing, additive manufacturing, subtractive manufacturing, etc.). The overall size of the support bracket 12, including the length, width, and depth or thickness of the support bracket 12 can vary.

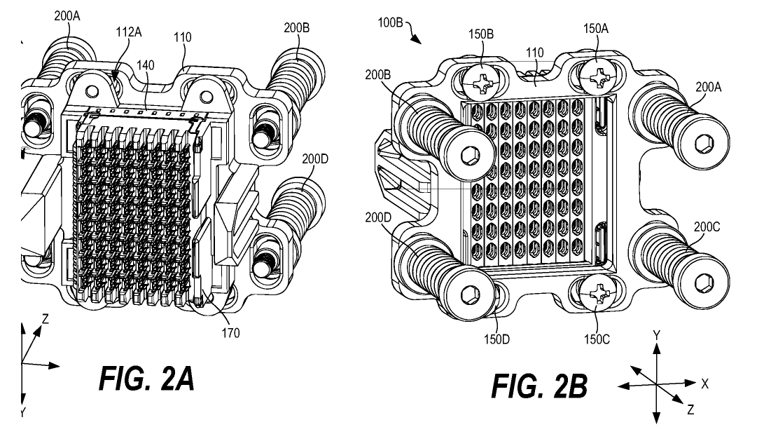

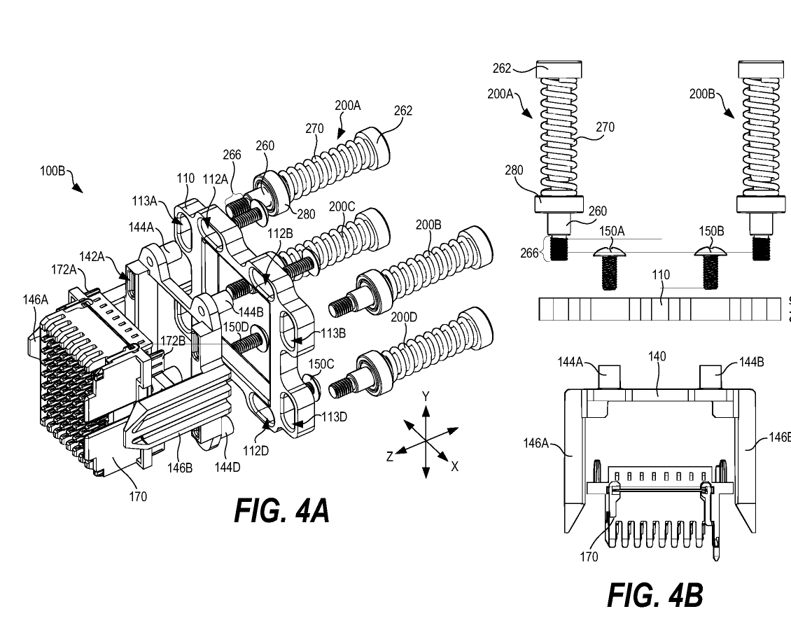

The connectors 100A-100C, among others that may be secured to and supported by the support bracket 12, are arranged in a type of linear array and are supported by the support bracket 12 in that configuration. Detailed views of the connector assembly 100A are shown in FIGS. 2A, 2B, 4A, and 4B and are described below. Each of the connectors 100A-100C extends through an opening or aperture in the support bracket 12. More particularly, the connectors 100A-100B extend through openings 30-32 in the support bracket 12, respectively, and other connectors in the rack assembly 10 can extend through other openings. The openings 30-32 are relatively larger than the housings of the connectors 100A-100C, so that a mechanical clearance is present between the housings of the connectors 100A-100C and the edges of the openings 30-32. Mating connectors (not shown) can be mechanically and electrically mated with the connectors 100A-100C, at the fronts of the connectors 100A-100C shown in FIG. 1A.

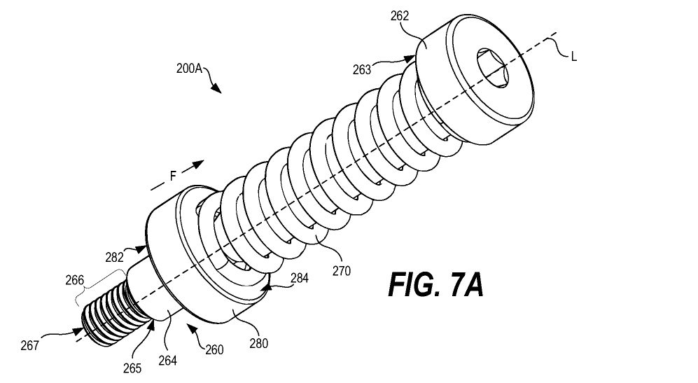

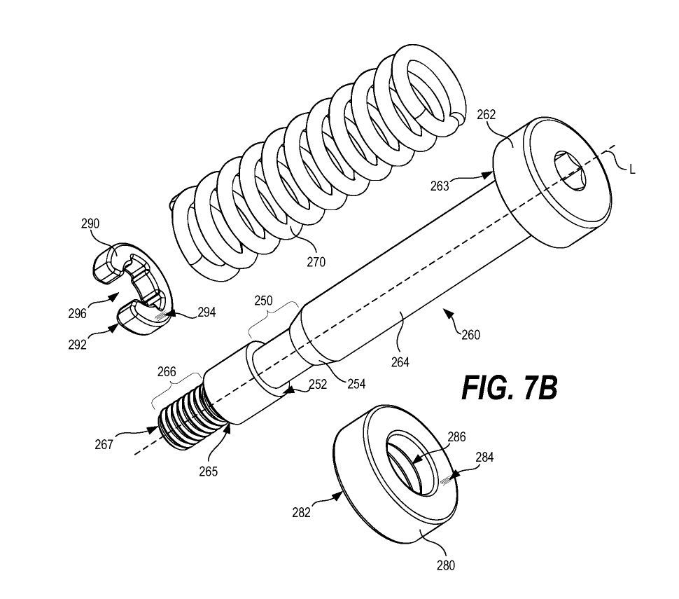

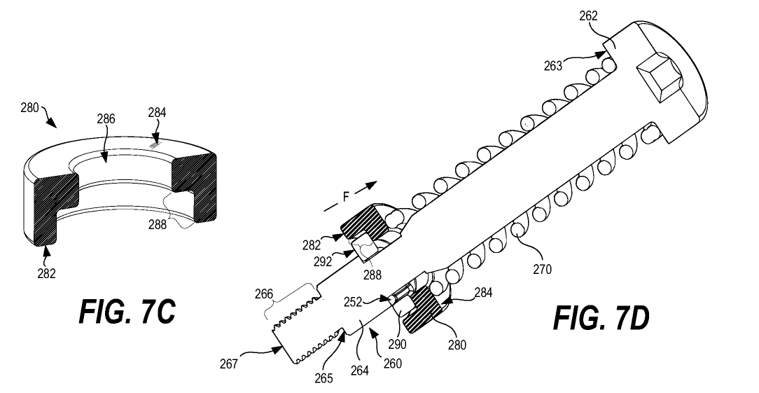

The connectors 100A-100C can be secured to the support bracket 12 using fasteners. According to the concepts described herein, the connectors 100A-100C are secured to the support bracket 12 using floating fasteners. In the example shown in FIG. 1A, the support bracket 12 of the rack assembly 10 includes threaded eyelets 40-43, among others. The connector 100A is secured to the support bracket 12 using floating fasteners, which are screwed into the threaded eyelets 40 and 41 of the support bracket 12 from the rear surface 12B of the support bracket 12. The connector 100B is also secured to the support bracket 12 using floating fasteners that are screwed into the threaded eyelets 42 and 43, among others, in the support bracket 12. The other connectors of the rack assembly 10 can also be secured to the support bracket 12 using floating fasteners and threaded eyelets in a similar way. Detailed views of floating fasteners are shown in FIGS. 7A-7D and described below.

The connectors 100A-100C in the rack assembly 10 are designed to operate as decoupled float connectors according to aspects of the embodiments. The connectors 100A-100C include a decoupling bracket and are fastened to the support bracket 12 through the decoupling bracket using floating fasteners, both which are described in further detail below. The decoupling bracket and floating fasteners are designed to allow at least some degree of movement in the X, Y, and Z directions shown in FIG. 1A, respectively and separately, between the connectors 100A-100C and the support bracket 12. The decoupling bracket and floating fasteners are also designed to reduce or substantially avoid rotation of the connectors 100A-100C within the openings 30-32 through the support bracket 12. The rack assembly 10 thus permits a level of flexibility, tolerance, or play in movement among the connectors 100A-100C, permitting the accommodation of variations in alignment position, angle, and forces applied to the connectors 100A-100C. The flexibility can be helpful to accommodate manufacturing tolerances, thermal expansion, vibration, and other factors that can result in relative movement or misalignment between connectors and connector assemblies. The decoupled float connectors and concepts described herein can also be helpful in applications where precise dimensional spacing is challenging among connectors, where shocks, over-mate conditions, vibrations, and other factors are expected, and in other situations.

FIG. 1B illustrates a rear view of parts of the example connector rack assembly 10 shown in FIG. 1A. Only the support bracket 12 and connectors 100A and 100C of the connector rack assembly 10 are shown in FIG. 1B, for simplicity. The connector 100A is an example of a cable-end connector assembly, as it can be positioned at the end of a bundle of cables (omitted from view and not shown in FIG. 1B). Signal and ground conductors of the cables are electrically coupled to and terminated at conductive signal terminals and ground shields, for example, within the connector 100A, as would be understood in the field. The concepts of decoupled float connector fasteners described herein are not limited to use with any particular type or style of connector or connector assembly, however, and the concepts can be applied to a range of other connectors and connector assemblies. The type, style, and form factor of the connectors 100A-100C are depicted as representative examples in FIGS. 1A and 1B, and the concepts described herein are not limited to use with any particular type or style of connector or connector assembly.

The connector 100B is omitted from view in FIG. 1B, so that the opening 31 through the support bracket 12 can be clearly shown. As noted above, the connector 100B can be positioned to extend through the opening 31 and secured to the support bracket 12 using floating fasteners. When the connector 100B is secured in place, a front part of the connector 100B extends beyond and in front of the front surface 12A of the support bracket 12, as shown in FIG. 1A, and a back part of the connector 100B extends beyond and behind the rear surface 12B of the support bracket 12. The back or rear parts of the connectors 100A and 100C are shown in FIG. 1B.

Each of the connectors 100A-100C, among others, can be secured to the support bracket 12 using floating fasteners. For example, floating fasteners can be positioned to extend through a decoupling bracket of the connector 100B and can be screwed into the threaded eyelets 42 and 43, among others, in the support bracket 12, to secure the connector 100B in place within the opening 31. The other connectors 100A and 100C can also be secured to the support bracket 12 using floating fasteners and threaded eyelets in a similar way. As described in further detail below, the floating fasteners permit the connector 100B to move in the Z direction shown in FIGS. 1A and 1B in response to applied force in the same direction. Floating fasteners also permit the connectors 100A and 100C, among others in the rack assembly 10, to move in the Z direction in response to applied force in the same direction.

Only the decoupling bracket of the connector 100B contacts the rear surface 12B of the support bracket 12 when the connector 100B is secured to the support bracket 12. Besides that contact, the opening 31 in the support bracket 12 is relatively larger than the housing and other components of the connector 100B, so that a mechanical clearance is available between the other components of the connector 100B and the edges of the opening 31. This clearance, and the decoupling bracket of the connector 100B, permit the connector 100B to move in the X and Y directions shown in FIGS. 1A and 1B. The decoupling brackets of the connectors 100A and 100C, among others, also permit the connectors 100A and 100B to move in the X and Y directions shown in FIGS. 1A and 1B. Thus, the connectors 100A-100C are referred to as decoupled float connectors, because the connectors 100A-100C can move to some degree or extent in the X, Y, and Z directions shown in FIGS. 1A and 1B, while also being secured to the support bracket 12. These and other aspects of the embodiments are described in further detail below.

FIG. 2A illustrates a front perspective view of the connector assembly 100B (also “connector 100B”) in the rack assembly 10 shown in FIGS. 1A, and 2B illustrates a back perspective view of the connector assembly 100B shown in FIG. 2A. The shape, size, proportion, and other characteristics of the connector 100B, and the respective parts or components of the connector 100B, can vary as compared to that shown in some cases. The connector 100B can include other parts or components that are not depicted in FIGS. 2A and 2B, and the connector 100B can also omit certain parts or components that are shown in FIGS. 2A and 2B in some cases. The connectors 100A and 100C, among others in the rack assembly 10 shown in FIG. 1A, can be similar to or the same as the connector 100B.

The connector 100B includes a decoupling bracket 110, a housing bracket 140 mounted with the decoupling bracket 110, a housing 170 mounted to the housing bracket 140, fasteners 150A-150D (also “fasteners 150”) that secure the housing bracket 140 together with the decoupling bracket 110, and floating fasteners 200A-200D (also “floating fasteners 200”). The connector 100B is an example of a cable-end connector assembly, as it can be positioned at the end of a bundle of cables (omitted from view and not shown in FIGS. 2A and 2B). The bundle of cables extends to the back of the connector 100B shown in FIG. 2B, through an opening in the decoupling bracket 110, and to conductive signal terminals and ground shields within the housing 170. In some cases, one or more wafer assemblies can be positioned and secured within the housing 170. In that case, the signal and ground conductors of the cables can be electrically coupled to and terminated at signal terminals and ground shields in wafer assemblies positioned within the housing 170, as one example understood in the field.

The decoupling bracket 110 can be formed from a relatively strong and rigid material, such as metal. As examples, the decoupling bracket 110 can be formed of aluminum, brass, steel or stainless steel, or another type of metal material. In other cases, the decoupling bracket 110 can be formed of a plastic or polymer, such as liquid crystal polymer (LCP), polyethylene (PE), polytetrafluoroethylene (PTFE), fluoropolymer, or other plastic or insulating material(s). In still other cases, the decoupling bracket 110 can be formed from a fiberglass, resin, composite material(s), or other suitable materials. The decoupling bracket 110 can be formed using any suitable additive or subtractive manufacturing techniques, including diecasting, molding, injection molding, printing, additive or subtractive manufacturing techniques, or other approaches.

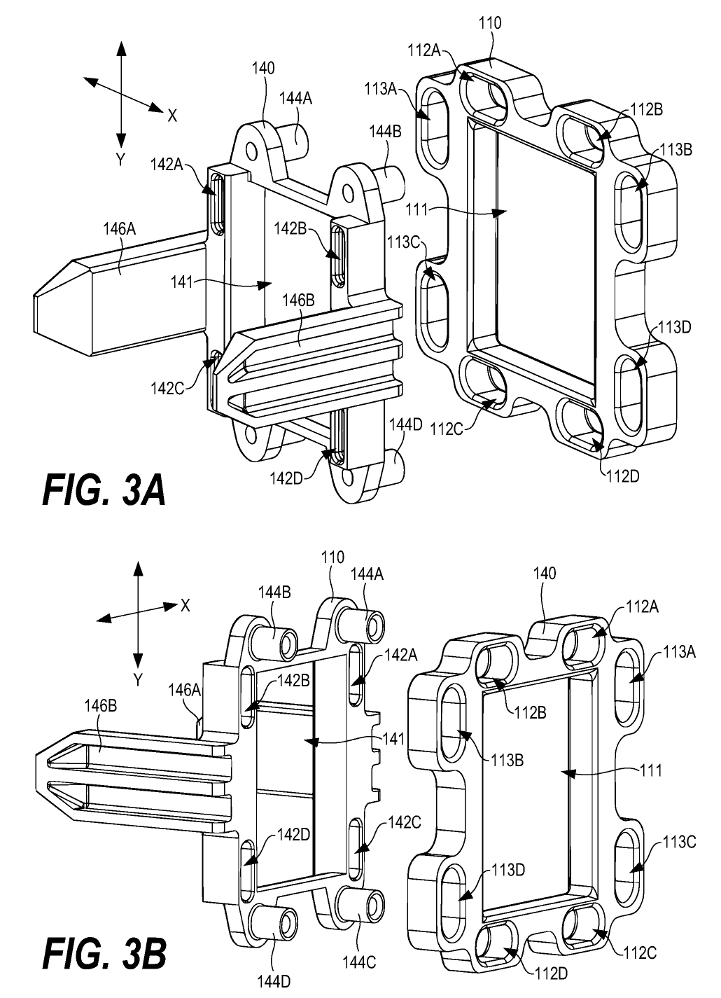

The decoupling bracket 110 includes a number of elongated apertures positioned around, along, or near a peripheral edge of the decoupling bracket 110. For example, the decoupling bracket 110 includes a first elongated aperture 112A (see FIG. 2A) that is elongated in a first direction and a second elongated aperture 113A (see FIG. 2A) that is elongated in a second direction perpendicular to the first direction. The first elongated aperture 112A is elongated in the X direction in the example shown in FIG. 2A. The second elongated aperture 113A is elongated in the Y direction in the example shown. The decoupling bracket 110 can include several apertures elongated in the first direction and several other apertures elongated in the second direction, as also shown in FIGS. 3A and 3B and described below. The elongated apertures permit the connector 100B, and particularly the housing 170 of the connector 100B, to float or move in the X and Y directions even when secured to the support bracket 12, as described in further detail below.

The housing bracket 140 can also be formed from a relatively strong and rigid material, such as metal. As examples, the housing bracket 140 can be formed of aluminum, brass, steel or stainless steel, or another type of metal material. In other cases, the housing bracket 140 can be formed of a plastic or polymer, such as LCP, PE, PTFE, fluoropolymer, or other plastic or insulating material(s). In still other cases, the housing bracket 140 can be formed from a fiberglass, resin, composite material(s), or other suitable materials. The housing bracket 140 can be formed using any suitable additive or subtractive manufacturing techniques, including diecasting, molding, injection molding, printing, additive or subtractive manufacturing techniques, or other approaches.

The respective materials from which the decoupling bracket 110 and the housing bracket 140 are formed can be selected in part based on the coefficients of static and kinetic friction between the decoupling bracket 110 and the housing bracket 140, among other factors. When the connector 100B is assembled, the housing bracket 140 is secured to the decoupling bracket 110 using the fasteners 150, and surfaces of the housing bracket 140 contact surfaces of the decoupling bracket 110. When assembled, the housing bracket 140 can move in the X direction shown in FIGS. 2A and 2B to some extent with respect to the decoupling bracket 110. The amount of force required to move the housing bracket 140 with respect to the decoupling bracket 110 can depend on the type and tightness of the fasteners 150 used to hold the housing bracket 140 to the decoupling bracket 110, any designed-for clearance between the housing bracket 140 and the decoupling bracket 110, the coefficients of static and kinetic friction between the respective material(s) of the decoupling bracket 110 and the housing bracket 140, and related factors.

The housing 170 can be formed from an insulating material in preferred embodiments. For example, the housing 170 can be formed from a plastic or polymer, such as LCP, PE, PTFE, fluoropolymer, or other plastic or insulating material(s). In other cases, the housing 170 can be formed from a metal, fiberglass, resin, glass, composite materials, or other suitable materials. The housing 170 can be formed using any suitable additive or subtractive manufacturing techniques, including molding, injection molding, printing, and other techniques. The housing 170 is fixedly mounted and secured to the housing bracket 140 when the connector 100B is assembled, as described in further detail below. In some cases, the housing 170 and the housing bracket 140 can be formed as a single, integral piece and be referred to collectively as a housing. In other cases, the housing 170 and the housing bracket 140 can be formed as separate pieces and secured together.

When the connector 100B is assembled, the housing bracket 140 is slidably mounted with the decoupling bracket 110 using the fasteners 150, such that the housing bracket 140 and the housing 170 can move or slide to some extent with respect to each other in the X direction shown in FIG. 2A. When the connector 100B is assembled with the rack assembly 10 shown in FIGS. 1A and 1B, the decoupling bracket 110 of the connector 100B is also slidably mounted against the rear surface 12B of the support bracket 12. For example, connector 100B is positioned through the opening 31 in the support bracket 12, with the front surface 114 of the decoupling bracket 110 contacting the rear surface 12B of the support bracket 12. The floating fasteners 200 are then extended through elongated apertures in the decoupling bracket 110 and threaded into the threaded eyelets 42 and 43 of the support bracket 12, among others. When assembled to the support bracket 12 using the floating fasteners 200, the decoupling bracket 110 can move or slide to some extent in the Y direction shown in FIGS. 1B and 2A.

Each of the floating fasteners 200A-200D includes a standoff screw and a bias spring, among other components described below. The standoff screws are inserted through the centers of the bias springs of the floating fasteners 200, so that the bias springs are coiled around the shanks of the standoff screws. The ends or tips of the standoff screws, which are threaded, can be inserted through elongated apertures of the decoupling bracket 110 and threaded into threaded eyelets of the support bracket 12, to secure the connector 100B to the support bracket 12. As an example, the tip of the standoff screw of the floating fastener 200A is shown extending through the elongated aperture 113A of the decoupling bracket 110 in FIG. 2A. The tip of the standoff screw of the floating fastener 200A can also be threaded into the threaded eyelet 42 of the support bracket 12 to secure the connector 100B to the support bracket 12. The other fasteners 200B-200C can also be used in a similar way to secure the connector 100B to the support bracket 12 of the rack assembly 10. Detailed views of the floating fastener 200A are shown in FIGS. 7A-7D and described below.

FIG. 3A illustrates a front perspective view of the housing bracket 140 and the decoupling bracket 110 of the connector assembly 100B shown in FIGS. 2A, and 3B illustrates a back perspective view of the housing bracket 140 and the decoupling bracket 110. The housing bracket 140 is formed and shaped as a type of rectangular ring and includes a central opening 141. The housing bracket 140 includes alignment blades 146A and 146B. The alignment blades 146A and 146B extend forward from the housing bracket 140, from right and left sides of the housing bracket 140, according to the orientation in FIGS. 3A and 3B. The alignment blades 146A and 146B can vary in size, shape, position, and other aspects in other embodiments, and housing bracket 140 can include additional, fewer, or no alignment blades in other examples. The alignment blades 146A and 146B may help to grossly align the housing of a mating connector with the housing 170 (see FIG. 2A) of the connector 100B.

The housing bracket 140 also includes a number of bushings 144A-144D (also “bushings 144”). The bushings 144 extend backward from the housing bracket 140, and each of the bushings 144A-144D extends back from a corner, or proximate to a corner, of the housing bracket 140. The bushings 144 are cylindrical in shape, in at least one example, and are sized to fit within elongated apertures of the decoupling bracket 110, as described below. The bushings 144 are inserted into the elongated apertures of the decoupling bracket 110 when the connector 100B is assembled. Each of the bushings 144A-144D is also threaded internally. More particularly, each of the bushings 144A-144D is internally threaded to mate with the external threading on one of the fasteners 150, which are threaded into the bushings 144.

The housing bracket 140 also includes a number of staking openings 142A-142D (also “staking openings 142”) formed near corners of the rectangular ring of the housing bracket 140. The staking openings 142 extend through from the front to the back of the rectangular ring of the housing bracket 140, as shown between FIGS. 3A and 3B. The staking openings 142 can be relied upon to secure the housing 170 of the connector 100B to the housing bracket 140. The housing 170 includes mounting stakes when molded, and the mounting stakes of the housing 170 can be inserted into staking openings 142 of the housing bracket 140. For example, the housing 170 includes mounting stakes 172A and 172B (see FIG. 4A, also “mounting stakes 172”), among others, and the mounting stakes 172 can be inserted into staking openings 142 of the housing bracket 140. The mounting stakes 172 can then be heat staked (e.g., heated, compressed, and re-formed) into staking heads positioned within the staking openings 142 in the housing bracket 140. This process will secure the housing 170 to the housing bracket 140, as a mechanical interference or interference fit between the staking heads of the housing 170 within the staking openings 142 in the housing bracket 140 secures the two components in place with respect to each other.

The decoupling bracket 110 is also formed and shaped as a type of rectangular ring and includes a central opening 111. The decoupling bracket 110 includes a number of elongated apertures positioned around, along, or near a peripheral outer edge of the decoupling bracket 110. In the example shown, the decoupling bracket 110 includes elongated apertures 112A and 112B positioned along a top of the of the decoupling bracket 110, elongated apertures 112C and 112D positioned along a bottom of the of the decoupling bracket 110, elongated apertures 113A and 113C positioned along one side of the of the decoupling bracket 110, and elongated apertures 113B and 113D positioned along an opposite side of the of the decoupling bracket 110.

The elongated apertures 112A-112D (also “elongated apertures 112”) are referred to herein as first elongated apertures 112. The elongated apertures 113A-113D (also “elongated apertures 113”) are referred to herein as second elongated apertures 113. Each of the elongated apertures 112A-112D and 113A-113D is formed as an extended or stretched opening, including a pair of inner surfaces that extend parallel to and face each over a length or distance and a pair of semicircular (i.e., circular arc measuring substantially 180°, π radians, or a half-turn) ends positioned at the ends of the parallel inner surfaces. The first elongated apertures 112 extend in a first direction and the second elongated apertures 113 extend in a second direction perpendicular to the first direction. In the example shown, the first elongated apertures 112 extend or are elongated in the X direction and the second elongated apertures 113 extend or are elongated in the Y, with the X direction running substantially orthogonal or perpendicular to the Y direction.

When the connector 100B is assembled, the bushings 144A-144D of the housing bracket 140 are positioned to fit within the elongated apertures 112A-112D, respectively, of the decoupling bracket 110. The fasteners 150A-150D are then threaded into the bushings 144A-144D, extending into the elongated apertures 112A-112D, to secure the housing bracket 140 with the decoupling bracket 110. The fasteners 150 can be embodied as machine screws, for example, sized in length to fit within and threaded to mate with the internal threads of the bushings 144. The heads of the fasteners 150 are larger than the first elongated apertures 112, so that the heads of the fasteners 150 cannot fit through the first elongated apertures 112. The bushings 144 and the fasteners 150 are formed or otherwise selected such that, when the fasteners 150 are fully threaded into the bushings 144, the heads of the fasteners 150 will contact the distal, outer rings of the bushings 144 rather than the back surface of the decoupling bracket 110.

The bushings 144 are cylindrical in shape, in at least one example. The bushings 144 are formed and sized such that the outer circumferences of the bushings 144 are smaller, or minimally smaller, than the distance between the parallel surfaces of the first elongated apertures 112. Thus, a clearance exists between the outer surface of the bushings 144 and the inner surface of the first elongated apertures 112, and the bushings 144 can move or slide within the first elongated apertures 112. As such, the housing bracket 140 and housing 170 can move or slide within the first elongated apertures 112 and with respect to the decoupling bracket 110 in the X direction. In other cases, rather than being cylindrical, the bushings 144 can be shaped similar to the first elongated apertures 112, having a pair of flat surfaces, and minimally smaller than the inner surfaces of the first elongated apertures 112. Other sizes and shapes of the bushings 144 are within the scope of the embodiments.

The standoff screws of the floating fasteners 200A-200D extend through the elongated apertures 113A-113D of the decoupling bracket 110, respectively, to assemble the connector 100B to the support bracket 12 of the of the rack assembly 10. Each of the floating fasteners 200A-200D includes a standoff screw 260 and a bias spring 270, as indicated in FIG. 4A, among other components described below. The standoff screws 260 are inserted through the centers of the bias springs 270 of the floating fasteners 200, so that the bias springs 270 are coiled around the shanks 264 of the standoff screws, shown in detail in FIG. 7A. The ends or tips of the standoff screws, which are threaded, are then inserted through the second elongated apertures 113 of the decoupling bracket 110 and threaded into threaded eyelets of the support bracket 12. The standoff screws of the floating fasteners 200 are sized to permit a clearance between the shanks of the standoff screws and the inner surfaces of the second elongated apertures 113. At the same time, the floating fasteners 200 apply a force against the decoupling bracket 110, pushing the decoupling bracket 110 against the rear surface 12B (see FIG. 1B) of the support bracket 12. The force applied by the floating fasteners 200 is sufficient to hold the decoupling bracket 110 and the connector 100B in place (e.g., based on friction) within the opening 31 of the support bracket 12, but the force can also be overcome to permit movement in the Y direction as described in additional detail below.

FIG. 4A illustrates another front perspective view of the connector 100B shown in FIG. 2A, with parts exploded away from each other, and FIG. 4B illustrates a top-down view of the connector 100B with parts exploded. FIGS. 4A and 4B show the decoupling bracket 110, the housing bracket 140, the housing 170, the fasteners 150, and the floating fasteners 200, arranged inline before being assembled together as the connector 100B.

To assemble the connector 100B, the mounting stakes 172 of the housing 170 are inserted into the staking openings 142 of the housing bracket 140. For example, the mounting stake 172A is inserted into the staking opening 142A of the housing bracket 140. The mounting stake 172A can then be heat staked (e.g., heated, compressed, and re-formed) into a staking head positioned within the staking opening 142A in the housing bracket 140. Other mounting stakes 172 of the housing 170 can also be heat staked into other staking openings 142 of the housing bracket 140, to secure the housing 170 to the housing bracket 140. To also assemble the connector 100B, the bushings 144A-144D of the housing bracket 140 are positioned to fit within the elongated apertures 112A-112D of the decoupling bracket 110. The fasteners 150A-150D are then threaded into the bushings 144A-144D, to secure the housing bracket 140 with the decoupling bracket 110.

The connector 100B can also be assembled to the support bracket 12 of the of the rack assembly 10 using the floating fasteners 200. The standoff screws of the floating fasteners 200A-200D can be extended through the elongated apertures 113A-113D of the decoupling bracket 110, respectively, and threaded into threaded eyelets in the support bracket 12. Referring to the floating fastener 200A as a more particular example, the floating fastener 200A includes a standoff screw 260, a bias spring 270, and a float bearing ring 280. The standoff screw 260 includes a head 262 at one end and a threaded region 266 at another end. The standoff screw 260 extends through the center of the bias spring 270, so that the bias spring 270 is coiled around the shank of the standoff screw 260.

The end of the standoff screw 260 can be inserted through the elongated aperture 113A of the decoupling bracket 110. The float bearing ring 280 will then contact, rest, and press upon the back surface of the decoupling bracket 110, around the elongated aperture 113A. The threaded region 266 at the end of the standoff screw 260 can then be threaded into the threaded eyelet 42 (see FIGS. 1A and 1B) of the support bracket 12, until the unthreaded end of the shank of the standoff screw 260 reaches the rear surface 12B of the support bracket 12. The other floating fasteners 200B-200D are structured and can be used in a similar way in connection with the elongated apertures 113B-113D and other threaded eyelets in the support bracket 12.

The standoff screw 260 of the floating fastener 200A is sized to permit a clearance between the shank of the standoff screw 260 and the inner surfaces of the elongated aperture 113A. Thus, the standoff screw 260 can move or slide to some extent within the elongated aperture 113A in the direction Y shown in FIG. 4A. At the same time, the floating fastener 200A applies a force against the decoupling bracket 110 and presses the decoupling bracket 110 against the rear surface 12B (see FIG. 1B) of the support bracket 12. More particularly, the float bearing ring 280 of the floating fastener 200A pushes the decoupling bracket 110 against the rear surface 12B of the support bracket 12, based on forces applied by the bias spring 270 pushing concurrently against the float bearing ring 280 and the head 262 of the standoff screw 260. The other floating fasteners 200B-200C operate in a similar way. The force applied by the floating fastener 200A, and the other floating fasteners 200B-200D, to the decoupling bracket 110 is sufficient to hold the connector 100B in place (e.g., based on friction) within the opening 31 of the support bracket 12, but the force can also be overcome to permit movement between the support bracket 12 and the decoupling bracket 110 in the Y direction. As discussed above, the housing 170 can also move with respect to the decoupling bracket 110 in the X direction, separately.

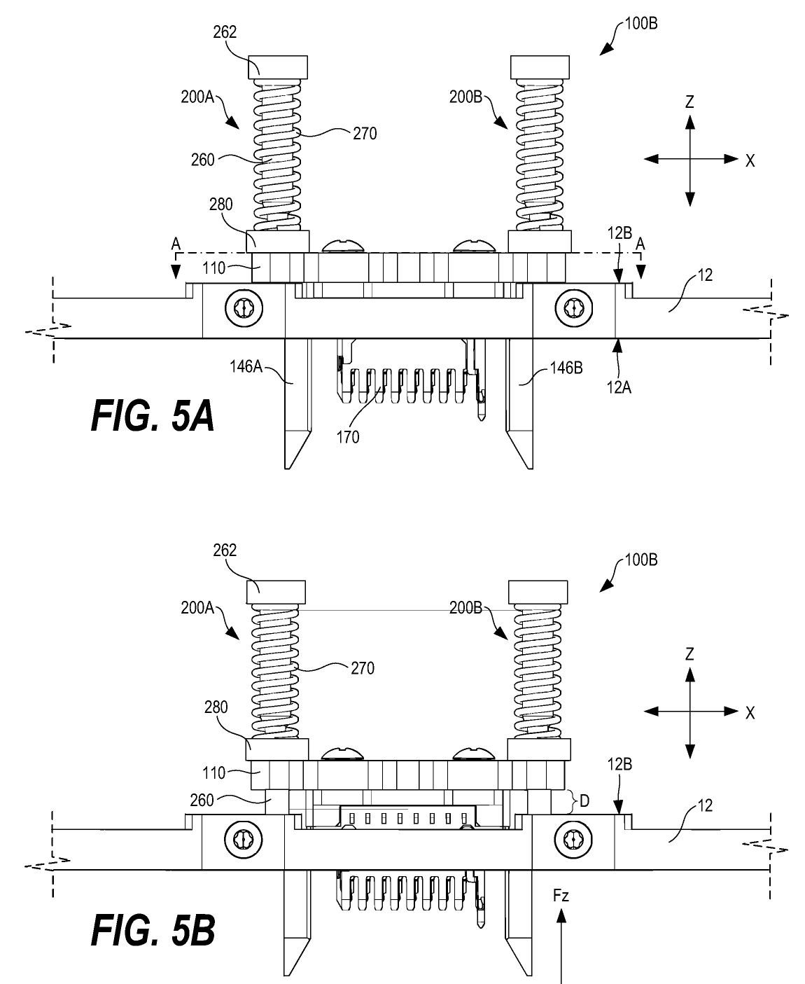

FIG. 5A illustrates a top-down view of parts of the rack assembly 10 shown in FIGS. 1A, and 5B illustrates another top-down view of parts of the rack assembly 10. FIG. 5A illustrates the connector 100B mounted to the support bracket 12 of the rack assembly 10 using the floating fasteners 200. The floating fasteners 200 and are designed to permit relative motion between the connector 100B and the support bracket 12 in at least one direction as forces act upon the connector 100B. Thus, as shown in a comparison between FIGS. 5A and 5B, the decoupling bracket 110 contacts the rear surface 12B of the support bracket 12 in FIG. 5A and is separated from the rear surface 12B in FIG. 5B. The decoupling bracket 110 is separated from the rear surface 12B by the space or distance D in the direction Z shown in FIG. 5B, and the floating fasteners 200 accommodate at least the separation distance D between the decoupling bracket 110 and the support bracket 12. The connector 100B can be moved in the direction Z, for example, when a mating connector is mated to the connector 100B, and a force F_{Z} is applied in the direction Z during that mating operation. The force F_{Z} must be greater than that offered by the combined spring biases of the floating fasteners 200, and the springs of the floating fasteners 200 can be designed accordingly.

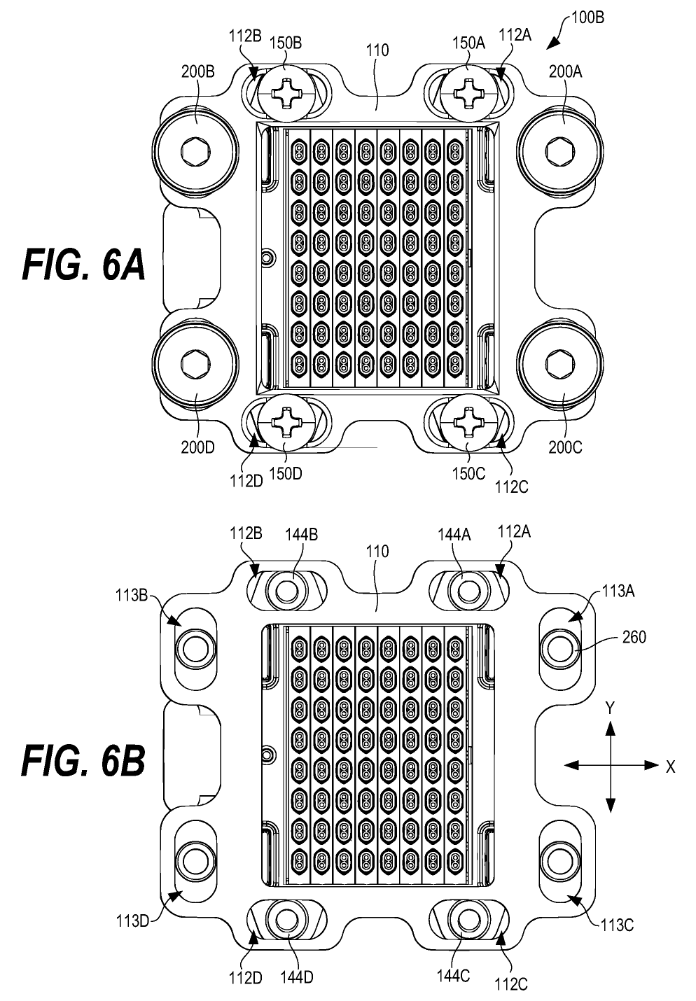

FIG. 6A illustrates a back view of the connector assembly 100B shown in FIGS. 2A, and 6B illustrates the sectional view of the connector assembly 100B designated A-A in FIG. 5A. FIG. 6A illustrates the positions of the fasteners 150A-150D, threaded into the bushings 144A-144D, which are positioned respectively in the elongated apertures 112A-112D of the decoupling bracket 110. The floating fasteners 200A-200D are also shown positioned respectively in the elongated apertures 113A-113D of the decoupling bracket 110.

With the heads of the fasteners 150 and the floating fasteners 200 sectioned out of the view in FIG. 6B, the bushings 144A-144D are clearly shown positioned within the elongated apertures 112A-112D. The standoff screws of the floating fasteners 200A-200D are also positioned within the elongated apertures 113A-113D. For example, the standoff screw 260 is positioned within the elongated aperture 113A. From the view shown in FIG. 6B, it is clear how the bushings 144A-144D can move or slide in the direction X within the elongated apertures 112A-112D. It is also clear how the standoff screws of the floating fasteners 200A-200D can move or slide in the direction Y within the elongated apertures 113A-113D. The lengths or sizes of the elongated apertures 112 and 113 can be tailored, as needed, to control the range of motion in the X and Y directions. The elongated apertures 112 and 113 have similar sizes in the example shown. In other cases, the first elongated apertures 112 can be larger or longer than the second elongated apertures 113, to permit more movement in the X direction than the Y direction. Alternatively, the second elongated apertures 113 can be larger or longer than the first elongated apertures 112, to permit more movement in the Y direction than the X direction.

According to the concepts of decoupled floating connectors described herein, the connector 100B is a floating connector of the rack assembly 10 because the connector 100B can move in one or more directions (e.g., the directions X, Y, and Z shown in FIG. 1A) with respect to the support bracket 12. The connector 100B is designed to both absorb and move or reposition itself, in response to forces associated with over-mate conditions, misalignments, and other conditions during mating operations. The connector 100B is also designed to facilitate manufacturing tolerances and the accommodation of variations in alignments, positions, angles, and forces among the connector 100B, the support bracket 12, and mating connectors to the connector 100B.

FIG. 7A illustrates a separate perspective view of the floating fastener 200A. FIG. 7B illustrates an exploded view of components of the floating fastener 200A. The floating fastener 200A is illustrated as a representative example and is not drawn to any particular scale or size. The shape, size, proportion, and other characteristics of the floating fastener 200A can vary as compared to that shown in other embodiments. In some cases, the floating fastener 200A can include additional parts of components that are not shown and described. In other cases, the floating fastener 200A can omit one or more of the components that are shown and described.

Referring between FIGS. 7A and 7B, the floating fastener 200A includes a standoff screw 260, a bias spring 270, a float bearing ring 280, and a locking clip 290. The standoff screw 260 can be embodied as any suitable size and style of screw, including a screw with a torx, star, Phillips, pin, or other type of head with any suitable style of threading (e.g., angle, pitch, and lead thread style). The standoff screw 260 includes a head 262, a shank 264, a threaded region 266, and a tip 267 at an end of the shank 264. The head 262 is formed as a recessed flat torx head in the example shown, although other types of heads can be relied upon. The threaded region 266 extends for a shorter distance along the longitudinal axis “L” of the standoff screw 260 than the shank 264. The threaded region 266 of the standoff screw 260 can be threaded into the threaded eyelet 42 of the support bracket 12 (see FIG. 1A), for example, until the shaft bearing surface 265 contacts the rear surface 12B (see FIG. 1B) of the support bracket 12, which prevents the standoff screw 260 from being threaded any further into the threaded eyelet 42.

As shown in FIG. 7B, the shank 264 of the standoff screw 260 includes a bearing slide region 250 that extends a distance along the longitudinal axis L of the shank 264. The size or length of the bearing slide region 250 is shown as an example in FIG. 7B and can vary as compared to that shown. The bearing slide region 250 is a length of the shank 264 that has a reduced outer surface circumference as compared to remaining portion of the shank 264. The bearing slide region 250 includes a locking rim 252 at one end and a taper ring 254 at another end. The locking rim 252 includes an annular ring surface extending in a plane that is substantially perpendicular to the longitudinal axis L of the shank 264. The taper ring 254 is a conical region that tapers from the reduced circumference of the bearing slide region 250, which is closer to the tip 267, to the increased circumference of the remaining shank 264, which is closer to the head 262. The function and purpose of the bearing slide region 250 is described in further detail below.

The bias spring 270 can be embodied as a spring formed from high-carbon spring steel, alloy spring steel, stainless spring steel, copper-based spring alloys, nickel-based spring alloys, or other suitable materials. The bias spring 270 can be selected or manufactured to have a suitable spring constant, k, for holding or biasing the connector 100B against the support bracket 12, along with the other floating fasteners 200B-200C. The spring constant, k, can also be selected for absorbing the forces applied to the connector 20 during over-mate conditions. The bias spring 270 can be formed to any suitable length, include any number of turns, and is sized so that the shank 264 of the standoff screw 260 can extend through the center of the bias spring 270 with a clearance between them.

The float bearing ring 280 can be formed as a ring formed of metal, polymer materials, or other suitable materials. The float bearing ring 280 includes a ring bearing surface 282 and a spring bearing surface 284, both of which are annular, flat, and extend in separate and substantially parallel planes. A central aperture 286 extends through the float bearing ring 280 and the surfaces 282 and 284. The locking clip 290 can be embodied as a C-shaped clip formed of metal, polymer materials, or other suitable materials. The locking clip 290 includes a lock bearing surface 292 and a float bearing surface 294. The lock bearing surface 292 and float bearing surface 294 are both flat and extend in separate and substantially parallel planes.

To assemble the floating fastener 200A, the tip 267 of the standoff screw 260 can be inserted through the center of the bias spring 270, so that the bias spring 270 is coiled around the shank 264 and positioned against the head 262 of the standoff screw 260 as shown in FIG. 7A. The tip 267 of the standoff screw 260 can also be inserted through the central aperture 286 of the float bearing ring 280. The float bearing ring 280 can be pushed against and contacted with the end of the bias spring 270. A force in the direction “F” shown in FIG. 7A can then be applied to the float bearing ring 280 to compress the bias spring 270 and reveal the bearing slide region 250. The locking clip 290 can then be snapped into and onto the bearing slide region 250 of the shank 264, and the float bearing ring 280 can be released. The float bearing ring 280 will then be biased to seat against the locking clip 290 by the extension of the bias spring 270.

FIG. 7C illustrates a sectional view of the float bearing ring 280 of floating fastener 200A. As shown in FIG. 7C, the float bearing ring 280 includes an annular recess 288. The size of the annular recess 288 is sufficient to encompass (i.e., extend around or extend over) the locking clip 290. In other words, the inner circumferential surface within the annular recess 288 is larger than the outer circumferential surface of the locking clip 290, with a clearance between them.

FIG. 7D illustrates a sectional view of the floating fastener 200A. As shown, the bias spring 270 is coiled around the shank 264. In the configuration shown in FIG. 7D, the bias spring 270 applies spring forces against the bearing surface 263 of the standoff screw, at one end, and against the spring bearing surface 284 of the float bearing ring 280, at another end. The shank 264 of the standoff screw 260 extends through the central aperture of the float bearing ring 280. The float bearing ring 280 is seated upon the locking clip 290, with the locking clip 290 being positioned within the annular recess 288 of the float bearing ring 280. The locking clip 290 contacts and is seated upon the locking rim 252 of the bearing slide region 250 (see FIG. 7B). Thus, the locking clip 290 provides a mechanical interference that prevents the bias spring 270 from pushing the float bearing ring 280 any further towards the tip 267 of the standoff screw 260, to the extent needed. The floating fastener 200A can be adjusted with the locking clip 290 based on the dimensions of the decoupling bracket 110 of the connector 100B, as needed.

The float bearing ring 280 can slide along the bearing slide region 250 (see FIG. 7B) and along the shank 264 of the standoff screw 260, toward the head 262 of the standoff screw 260, based on application of a force in the direction F shown in FIG. 7A. That is, to the extent that the force in the direction F overcomes the spring bias provided by the bias spring 270, the float bearing ring 280 can slide along the bearing slide region 250 and the shank 264 of the standoff screw 260. The locking clip 290, on the other hand, can slide along the bearing slide region 250 but cannot slide along the shank 264 of the standoff screw 260. Instead, the taper ring 254 (see FIG. 7B) prevents the locking clip 290 from sliding past or beyond the bearing slide region 250.

The floating fastener 200A is designed to secure the connector 100B, as an example, against the support bracket 12 in the manner shown in FIGS. 1A, 5A, and 5B. The floating fastener 200A is also designed to absorb forces associated with over-mate conditions of the connector 100B. Thus, forces associated with over-mate conditions, such as a force in the direction F shown in FIG. 7A, will counteract against and overcome the spring bias provided by the floating fastener 200A. The floating fastener 200A is designed to facilitate manufacturing tolerances and the accommodation of variations in alignments, positions, angles, or forces among the connector 100B and the support bracket 12. Depending on the direction of the forces applied to the connector 100B, the floating fastener 200A can also permit the connector 20 to move in the X and Y directions, as described above. The floating surfaces 292 and 282 of the floating fastener 200A, taken in combination with the other fasteners 200B-200C, can be pre-loaded with a spring bias that is greater than the typical maximum mating forces applied to the connector 100B, during mating.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The mechanical couplings described herein can be achieved in alternative ways in some cases. For example, rather than a screw being threaded into a threaded aperture or eyelet, other mechanical couplings can be relied upon in some cases, such as friction fits, rivets, welds, and other means.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A rack assembly, comprising:
a support wall comprising an opening; and
a connector assembly extending through the opening and being mounted to the support wall with a floating fastener, the connector assembly comprising:
a decoupling bracket comprising a first elongated aperture and a second elongated aperture, the first elongated aperture being elongated in a first direction and the second elongated aperture being elongated in a second direction perpendicular to the first direction;
a housing bracket mounted with the decoupling bracket using a fastener extending into the first elongated aperture; and
a housing mounted to the housing bracket; wherein:
the connector assembly is mounted to the support wall with the floating fastener extending through the second elongated aperture of the decoupling bracket.

2. The rack assembly according to claim 1, wherein the first elongated aperture is positioned along a first peripheral edge of the decoupling bracket, and the second elongated aperture is positioned along a second peripheral edge of the decoupling bracket.

3. The rack assembly according to claim 1, wherein:
the housing bracket comprises a bushing;
the bushing extends into the first elongated aperture of the decoupling bracket; and
the fastener is threaded into the bushing, within the first elongated aperture.

4. The rack assembly according to claim 3, wherein the bushing can slide within the first elongated aperture in the first direction.

5. The rack assembly according to claim 1, wherein a shank of a standoff screw of the floating fastener can slide within the second elongated aperture in the second direction.

6. The rack assembly according to claim 1, wherein:
the first elongated aperture comprises a first plurality of elongated apertures each elongated in the first direction; and
the second elongated aperture comprises a second plurality of elongated apertures each elongated in the second direction.

7. The rack assembly according to claim 6, wherein:
the floating fastener comprises a plurality of floating fasteners; and
each floating fastener among the plurality of floating fasteners extends through a respective second elongated aperture among the second plurality of elongated apertures of the decoupling bracket and is secured into a threaded aperture in the support wall.

8. The rack assembly according to claim 6, wherein:
the housing bracket comprises a plurality of bushings; and
each bushing among the plurality of bushings extends into a respective first elongated aperture among the first plurality of elongated apertures of the decoupling bracket.

9. The rack assembly according to claim 1, wherein the floating fastener comprises:
a bias spring;
a float bearing ring that contacts the decoupling bracket; and
a standoff screw comprising a head with a bearing surface and a shank, the shank extending through a center of the bias spring and through the float bearing ring, wherein the bias spring extends and applies forces against the bearing surface of the standoff screw and against the float bearing ring.

10. A connector assembly, comprising:
a decoupling bracket comprising a first elongated aperture and a second elongated aperture, the first elongated aperture being elongated in a first direction and the second elongated aperture being elongated in a second direction perpendicular to the first direction; and
a housing mounted with the decoupling bracket using a fastener extending into the first elongated aperture.

11. The connector assembly according to claim 10, further comprising:
a housing bracket, wherein:
the housing is mounted to the housing bracket; and
the housing bracket is mounted with the decoupling bracket using the fastener extending into the first elongated aperture.

12. The connector assembly according to claim 10, wherein the first elongated aperture is positioned along a first peripheral edge of the decoupling bracket, and the second elongated aperture is positioned along a second peripheral edge of the decoupling bracket.

13. The connector assembly according to claim 10, wherein:
the housing comprises a bushing;
the bushing extends into the first elongated aperture of the decoupling bracket; and
the fastener is threaded into the bushing, within the first elongated aperture.

14. The connector assembly according to claim 13, wherein the bushing can slide within the first elongated aperture in the first direction.

15. The connector assembly according to claim 10, wherein the connector assembly is mounted to a support wall with a floating fastener extending through the second elongated aperture of the decoupling bracket.

16. The connector assembly according to claim 15, wherein a shank of a standoff screw of the floating fastener can slide within the second elongated aperture in the second direction.

17. The connector assembly according to claim 10, wherein:
the first elongated aperture comprises a first plurality of elongated apertures each elongated in the first direction; and
the second elongated aperture comprises a second plurality of elongated apertures each elongated in the second direction.

18. A connector assembly, comprising:
a decoupling bracket comprising a first elongated aperture;
a housing comprising a bushing; and
a fastener, wherein:
the bushing extends into the first elongated aperture of the decoupling bracket; and
the fastener is mechanically coupled with the bushing, within the first elongated aperture.

19. The connector assembly according to claim 18, wherein:
the first elongated aperture is elongated in a first direction;
the decoupling bracket further comprises a second elongated aperture elongated in a second direction perpendicular to the first direction;
the first elongated aperture is positioned along a first peripheral edge of the decoupling bracket; and
and the second elongated aperture is positioned along a second peripheral edge of the decoupling bracket.

20. The connector assembly according to claim 19, wherein the connector assembly is mounted to a support wall with a floating fastener extending through the second elongated aperture of the decoupling bracket.
